(19) United States
(12) Patent Application Publication
(10) Pub. No.: US 2018/0189012 A1
(43) Pub. Date: Jul. 5, 2018

(54) Double Screen Laptop

(71) Applicant: Yinjia FANG, Castro Valley, CA (US)

(72) Inventor: Yinjia FANG, Castro Valley, CA (US)

(21) Appl. No.: 15/396,448

(22) Filed: Dec. 31, 2016

(51) Int. Cl. G06F 3/14; G06F 1/16

(52) U.S. Cl. CPC G06F 3/1423; G06F 1/1681

(57) ABSTRACT

The invention discloses a laptop device which has a capability of a dual screen option such that a user can use two separate software applications on different screens. In this invention, a well built and ergonomically strong laptop device with powerful processing capabilities for day to day use along with more advanced application usage includes embodiments such as having a secondary screen which is communicatively coupled to the processor of the laptop. One option is to align the secondary laptop with the main screen of the laptop for side by side use. The secondary screen is embedded in a standalone layer underneath the keyboard of the laptop and can be pulled out aligned side by side with the main screen. In another embodiment of the invention, a secondary screen is hinged on to the top of the main screen for the user to view dual screens, one above the other, while working on the laptop.

### FIELD OF THE INVENTION

The present invention generally relates to the field of computers and computers screens. More particularly, the invention relates to laptop computers having a primary screen and a secondary screens to work from.

### BACKGROUND OF THE INVENTION

A laptop is a small, portable personal computer with a clamshell form factor, an alphanumeric keyboard on the lower part of the clamshell and a thin LCD or LED computer screen on the upper portion, which is opened up to use the computer. Laptops are folded shut for transportation. It combines the components, inputs, outputs, and capabilities of a desktop computer, including the display screen, small speakers, a keyboard, pointing devices (such as a touchpad or trackpad), a processor, and memory into a single unit. Most 2016-era laptops also have integrated webcams and built-in microphones.

As computer technology continues to rapidly develop, laptops in particular, continue to develop faster processing power which enables them to run more and more complex applications. Also with modern mobile communication technology, wireless network technology, laptops continue to work in conjunction with smart phones and other wireless products to send and receive information. With globalization continuing to evolve and develop at the same time as well, one industry in particular, requires the use of laptop computers and notebooks to enable their employees to work and communicate with colleagues and customers all over the world more than ever.

This industry which includes software programming companies which focus on programming and software development now plays a role in almost every aspect of technology growth and advancement. Smart systems and programs are implemented in many products and devices to enable ease of use. This industry has also lead the movement in working away from the standard 40 hour work week in the office. Employees are now capable of working outside of the office due to the nature of the work and new thinking by industry leaders to accommodate a work/life balance for employees.

With this change and movements, employees are able to work from home, at coffee shops, and also while traveling on the road while also remaining productive to perform work tasks. With this movement, laptop screens often need more viewing capacity than the standard screen. One example of a dual screen computer/notebook is US Publication No. 20020158811A1, Dual Monitor Duo-work pad TM Device to Terry Davis. Although this is a thin notebook computer with dual connected touchscreen monitors that fold open to be used like a book or in a flat position, this device has its limitations. One of the main limitations of this invention is meant for thin notebooks for simple and practical uses such as reading an e-book or surfing the web. Laptops which are used by coders and programmers for advanced coding purposes for example, cannot use the dual screen notebook described in Davis's invention.

Another laptop computer described in US Publication No. 20120243165A1 to Yao-Tsung Chang et al also is a dual screen invention. This dual screen computer screen includes a display module and a body and the display module includes a first screen and a second screen. However, the two screens are separately disposed on opposite sides of the display module. The invention also has the capability of switching from a laptop to a tablet. This invention is also useful for the day to day user and common usage of the laptop computer such as browsing the web, or reading an e-book. Again, this invention would not suit a user who may require a more advanced application use. Experienced software developer or programmer for example, who may need side by side dual screens to compare codes for debugging purposes would not be able to use Chang's invention. Also the invention to Yao-Tsung Chang et al is not intended for advanced laptops with strong processors and capabilities to handle powerful coding platforms either.

Therefore what is needed is a well built, ergonomically strong laptop which has the capability of having a dual screen option if needed. The secondary screen would be communicatively coupled to the processor of the laptop so that the user can use dual screens while operating a single laptop. A laptop with an option to pull out a second screen or activate an existing second screen hinged to the main screen could be useful and helpful for the software programmers who work on laptops away from the office, and the dual screen can be used for several other applications and purposes, not just limiting the use to software programming purposes.

### SUMMARY OF THE INVENTION

Accordingly, the present invention discloses a laptop device which has the capability of having a dual screen option. In this invention a well built and ergonomically strong laptop device with powerful processing capabilities for day to day use along with more advanced application usage includes embodiments such as having a secondary screen which is communicatively coupled to the processor of the laptop. One option is to align the secondary laptop with the main screen of the laptop for side by side use. The secondary screen is embedded in a standalone layer underneath the keyboard of the laptop and can be pulled out aligned side by side with the main screen. In another embodiment of the invention, a secondary screen is hinged on to the top of the main screen for the user to view dual screens, one above the other, while working on the laptop.

### First Preferred Embodiment and Best Mode

In the first preferred embodiment of the invention which is also the best mode, the laptop device includes a secondary screen which can be pulled out from the back side of the main screen. In this embodiment, the secondary screen can be the same size as the main screen or it can be slightly smaller depending on the user's preference. Again, the laptop is built bulkier and stronger than standard laptops to withstand the top heavy weight of the secondary screen.

The option for both screen sizes is available, and if the secondary screen is not in use, the stronger material used for manufacturing allows the main screen to stand up right during use. Further, with the push of a release and lock button on the side of the laptop, the secondary screen is released out from the back side of the main screen. It can then be grabbed and pulled out to the right side of the main screen. Once the secondary screen is pulled out to the right side, a rail guided mechanism allows the user to pull the secondary screen forward to be flush in the same plane as the main screen.

Spring loaded hooks can be pushed into the through holes on the right side of the main screen to mate both the main screen and the secondary screen flush on the same plane. A hinged feature on the right side of the main screen then allows the screen to be pushed forward at an angle to give the user different angles of user experience. As will be mentioned in the next embodiments as well, the secondary screen is communicatively coupled to the processor of the main laptop enabling the user to place at least two computer applications or documents on each of the two screens for use.

### Second Preferred Embodiment

The second preferred embodiment is the laptop device with a standalone layer underneath the keyboard of the laptop. In this standalone layer, a smaller than the primary screen, secondary computer screen coupled to an extending shaft member can be pulled out of the standalone layer with the click of a release and lock button on the side of the laptop. The standalone layer underneath the keyboard is below the computer components layer and with the click of the button on the side of the laptop, the secondary screen springs out enough so that the user can grab and pull the screen and shaft member out together with an angle.

The extending shaft member rotatably coupled to the secondary screen can be aligned to the main screen of the laptop once the secondary screen is pulled out. This creates a dual screen laptop. At one end of the secondary screen, a column of spring loaded metallic hooks are spaced equally apart. Once the secondary laptop is rotated up to align to the main screen, the spring loaded metallic hooks can be pushed into side holes on the side of the main screen to couple and align the secondary laptop screen to the main screen.

### Third Preferred Embodiment

In yet another embodiment of the present invention, the laptop device has a standalone layer underneath the keyboard of the laptop. In this standalone layer, a secondary computer screen coupled to an extending shaft member can be pulled out of the standalone layer with the click of a button on the side of the laptop. The standalone layer underneath the keyboard is below the computer components layer and with the click of the button on the side of the laptop, the secondary screen springs out enough so that the user can grab and pull the screen and shaft member laterally out together. The extending shaft member rotatably coupled to the secondary screen can be aligned to the main screen of the laptop. At one end of the secondary screen, a column of spring loaded metallic hooks are spaced equally apart. Once the secondary laptop is rotated up to align to the main screen, the spring loaded metallic hooks can be pushed into side holes on the side of the main screen to couple and align the secondary laptop screen to the main screen. This embodiment also has the option of not mating the first and second screen. It is all dependent on the user's preference. The secondary screen can have a gap between it and the main screen.

### Fourth Preferred Embodiment

In yet another preferred embodiment of the present invention is the laptop device with a hinged secondary screen on top of the main screen. In this embodiment, the laptop is built with a stronger and thicker material to withstand the secondary screen's top weight. The secondary screen folds up and can be positioned directly above the main screen of the laptop. Users that compare coding in software applications for example, may require the secondary screen to be directly above the main screen.

While other users for other various applications may prefer the angled secondary screen for other purposes such as viewing angle preference. With the hinged mechanism feature, which is similar to the way a door is hinged to a door frame, the secondary top screen can be adjusted to the user's preferred viewing angle. The bulkier built laptop frame, keyboard, and main screen can maintain the center of gravity of the laptop device to prevent any imbalance or tipping. The user is able to use the laptop's main screen and push information on to the secondary screen above the main screen. This benefits the user by allowing more screen availability to work more productively and efficiently. As mentioned in the previous two embodiments, the secondary screen is communicatively coupled to the processor of the main laptop enabling the user to place at least two computer applications or documents on each of the two screens.

### BRIEF DESCRIPTION OF THE DRAWINGS

The features and advantages of the invention will be apparent from the following detailed description in conjunction with the drawings in which:

FIG. 1A is an illustration of the front view of the laptop device and the inventive secondary screen is shown being pulled out from the back side of the main screen.

FIG. 1B is an illustration of the front view of the laptop device and the inventive secondary screen is shown completely pulled out from the rear side of the main screen while tilted at an angle.

FIG. 2A is an illustration of the front view of the laptop device, and in this embodiment, the inventive secondary screen is shown being pulled out from the standalone layer beneath the keyboard in an angled movement away from the laptop's keyboard area.

FIG. 2B is an illustration of the front view of the laptop device, and the inventive secondary screen is shown completely pulled out to its fixed upright position from underneath the keyboard, and from its standalone layer.

FIG. 3A is an illustration of the front view of the laptop device, and the inventive secondary screen is shown being pulled out from the standalone layer beneath the keyboard in a lateral movement away from the laptop.

FIG. 3B is an illustration of the front view of the laptop device, and the inventive secondary screen is shown completely pulled out laterally from its standalone layer to its fixed upright position from underneath the keyboard.

FIG. 4A is an illustration of the front view of the laptop device, and the inventive secondary screen is hinged on to the top of the main screen and shown in its upright position.

FIG. 4B is an illustration of an isometric view of one embodiment of the invention, and the secondary screen is shown flipped back to touch the desk or table surface so as to be used for stability of the laptop device.

### DETAILED DESCRIPTION OF THE DRAWINGS

While the present invention may be embodied in different, forms, designs, or configurations, for the purpose of presenting an understanding of the principles of the invention, references will be made to the embodiments illustrated in the diagrams and drawings. Specific language will be used to describe the embodiments. Nevertheless it is intended to show that no limitation or restriction of the scope of the invention is thereby intended. Any alterations and further implementations of the principles of this invention as described herein are as they would normally occur to one skilled in the art to which the invention relates.

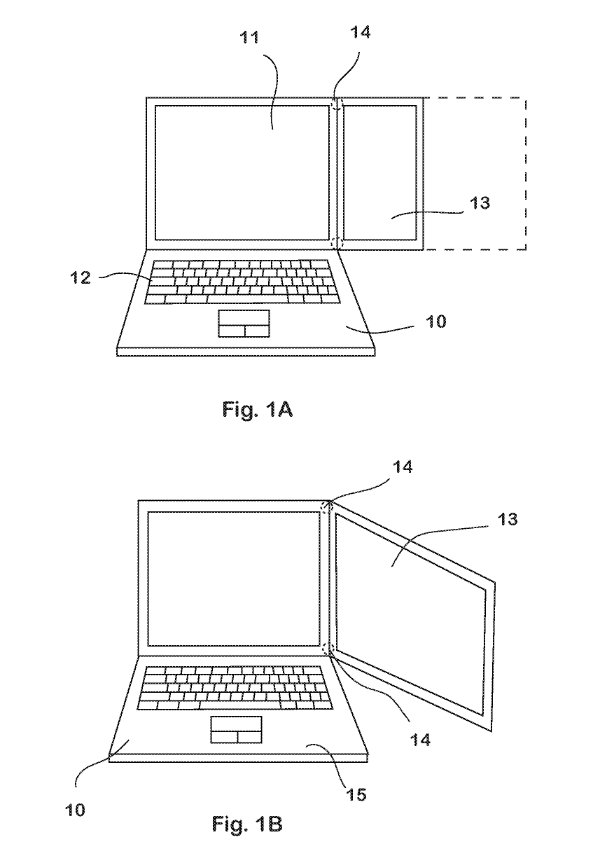

FIG. 1A is the front view illustration of the laptop device 10. In this view, the main or primary screen 11 is mechanically and electronically connected to the keyboard section 12. During the manufacturing process of the laptop device, the main screen component of the laptop has a thickness to accommodate the secondary screen 13. With the push of a lease and lock button (not shown) on the side of the keyboard section 12, the secondary screen 13 can be popped open from the back side of the main screen 11 which has a secondary layer to accommodate the secondary screen 13. Once the secondary screen 13 is popped open, the user can grab and pull the secondary screen 13 out to have the option of using a second screen. The push button feature is very similar to many notebooks and laptop models that carry the DVD/DVR device.

The push button allows the DVD/DVR slot to pop open just enough for the user to be able to grab and pull the slot out to install a DVD/DVR. This technology is again used in the present invention, but in this case, it is used to pull out the secondary screen 13 from behind the main screen 11. Once the secondary screen 13 is pulled out by the user, a short guided rail (not shown) can guide the secondary screen back and forth to make it align with the main screen 11. Thereafter, a set of spring loaded hooks (not shown) can be pushed out from the left side of the secondary screen and pushed into the through holes (not shown) on the right side of the main screen 11. Once the spring loaded hooks are pressed into the through holes, the secondary screen 13 can be mated and flushed up against the main screen 11. Once the user is finished working with the second screen, the push button (not shown) on top of the secondary screen can push the spring loaded hooks out and away from the through holes to separate the secondary screen 13 from the main screen 11.

However, once the secondary screen 13 is coupled to the main screen 11, two hinges 14 at the top and bottom of main screen 11 can then allow the secondary screen to be rotated and moved to different angles per the user's preference.

As shown in FIG. 1B, the two hinges 14 can be used once the secondary screen 13 is coupled to the main screen 11. Having the option to rotate the secondary screen with the two hinges 14 provides the user added benefits as opposed to fixing the secondary screen 13 to the main screen 11. If the user is confined for space if she is on an airplane for example, the secondary screen 13 can be rotated inward. As users travel, the work space is limited, and many users who are software programmers for example, have the need to compare two separate or two identical codes for debugging purposes.

The secondary screen 13 allows the user to bring up two screens and rotate the secondary screen 13 for the user's preference or outside limitations to perform the debugging of the software code.

The secondary screen 13 can be rotated to a full 90 degrees for flexibility. The base of the computer 15 is built with a stronger aluminum alloy material and a thicker frame to be able to hold the weight of two screens during use. Aluminum is also used for the components surrounding the main screen 11 including the frame. This allows the ease of manufacturing to include the through holes on the right side along with the strength to hold two screens into the laptop device's 10 upper portion which includes the main screen 11, and secondary screen 13.

Alternatively, the secondary display screen can be implemented as a standalone layer residing in a hollow space behind the primary display screen's framework. The secondary display screen is mechanically coupled to an extending shaft member that is further coupled to a release and lock button on the primary screen's side. When the release and lock button is pushed to release, the standalone layer with the secondary display screen springs out enough such that a user can grab and pull the secondary display screen with the shaft member out together, and then the secondary screen can be aligned to the primary screen.

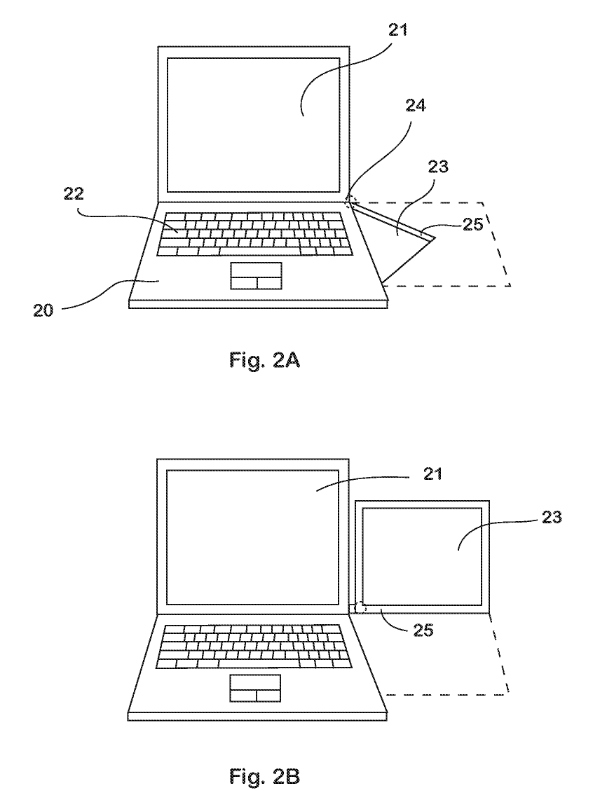

FIG. 2A is an illustration of the front view of the laptop device 20. In this embodiment of the present invention, the secondary screen 23 is shown coming halfway out of a secondary layer (not shown) beneath the keyboard layer 22. The laptop device 20 is built thicker to accommodate for a secondary layer which stores the secondary screen 23. A release and lock push button on the right side of the laptop device 20 can be pressed by the user to eject out the secondary screen 23 from the secondary layer. In this embodiment, the secondary screen 23 can be grabbed and pulled by the user, and the secondary screen 23 pivots from pivot point 24 which is built into the secondary layer.

A shaft member 25, is coupled to the pivot point 24 while also being rotatably attached to the bottom of the secondary screen 23. This enables the user to grab and pull out the secondary screen 23 at an angle and extend the secondary screen 23 ninety degrees to align it with the main screen 21. The shaft member 25 is rotatably attached to the secondary screen 23 which then further allows the secondary screen 23 to be rotated upright and align with the main screen 21. In this embodiment, the secondary screen 23 does not need mate flush with the main screen 21. A gap may exist since it may not be necessary to mate both screens. The spring loaded hook technology can also be implemented in this embodiment, but the user has the option for a gap or flush mating with the main screen 21.

A user may only need the secondary screen to compare software codes for example, and the user can scroll the computer mouse back and forth between the main screen 21 and the secondary screen 23 to perform a task. The secondary screen 23 may be smaller in size in comparison to the main screen 21 as shown in FIG. 2B.

FIG. 2B also shows the secondary screen 23 in a position which is aligned to the main screen 21. The shaft member 25 is shown extended out while the secondary screen 23 is in the upright position. With laptops now being an integral tool for several various professions, and the power of microprocessors being capable of performing so many more tasks, a secondary screen, such as the one shown in FIG. 2B is becoming more and more essential for users. With the simple rotate of the shaft member 25, the secondary screen 23 can be bent back down to its secondary layer position and pushed back to be put away if it is no longer needed. The technology of grabbing and pulling out the secondary screen 23 is taken from existing laptops' DVD/DVR port. In this case however, a novel and useful secondary screen is pulled out from a secondary layer to allow users to be more productive when performing a task or doing work.

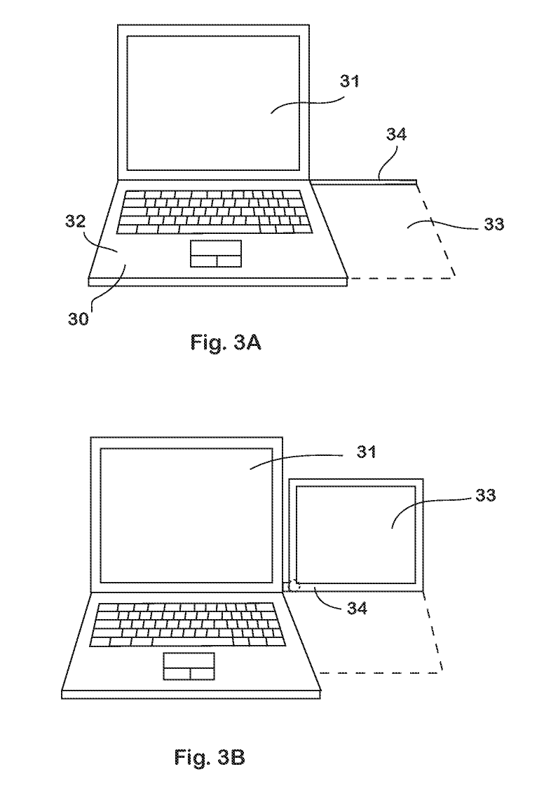

FIG. 3A is an illustration of the front view of the laptop device 30. In this embodiment of the present invention, the secondary screen 33, is shown coming halfway out of a secondary layer (not shown) beneath the keyboard layer 32. The laptop device 20 is built thicker to accommodate for a secondary layer which stores the secondary screen 23. A release and lock push button (not shown) on the right side of the laptop device 30 can be pressed by the user to eject out the secondary screen 33 from the secondary layer. In this embodiment, the secondary screen 33 can be grabbed and pulled by the user, and the secondary screen 33 extends out from the secondary layer.

A shaft member 34 is rotatably attached to the bottom of the secondary screen 33. This enables the user to grab and pull out the secondary screen 33 at an angle and extend the secondary screen 33 ninety degrees to align it with the main screen 31. The shaft member 34 is rotatably attached to the secondary screen 33 which then further allows the secondary screen 33 to be rotated upright and align with the main screen 31. In this embodiment, the secondary screen 33 does not need mate flush with the main screen 31. A gap may exist since it may not be necessary to mate both screens. A user may only need the secondary screen to compare software codes for example, and the user can scroll the computer mouse back and forth between the main screen 31 and the secondary screen 33 to perform a task. The secondary screen 33 may be smaller in size in comparison to the main screen 31 as shown in FIG. 3B.

FIG. 3B also shows the secondary screen 33 in a position which is aligned to the main screen 31. The shaft member 34 is shown extended out while the secondary screen 33 is in the upright position. With laptops now being an integral tool for several various professions, and the power of microprocessors being capable of performing so many more tasks, a secondary screen, such as the one shown in FIG. 2B is becoming more and more essential for users. With the simple rotate of the shaft member 34, the secondary screen 33 can be bent back down to its secondary layer position and pushed back to be put away if it is no longer needed. The technology of grabbing and pulling out the secondary screen 33 is taken from existing laptops' DVD/DVR port. In this case however, a novel and useful secondary screen is pulled out from a secondary layer to allow users to be more productive when performing a task or doing work.

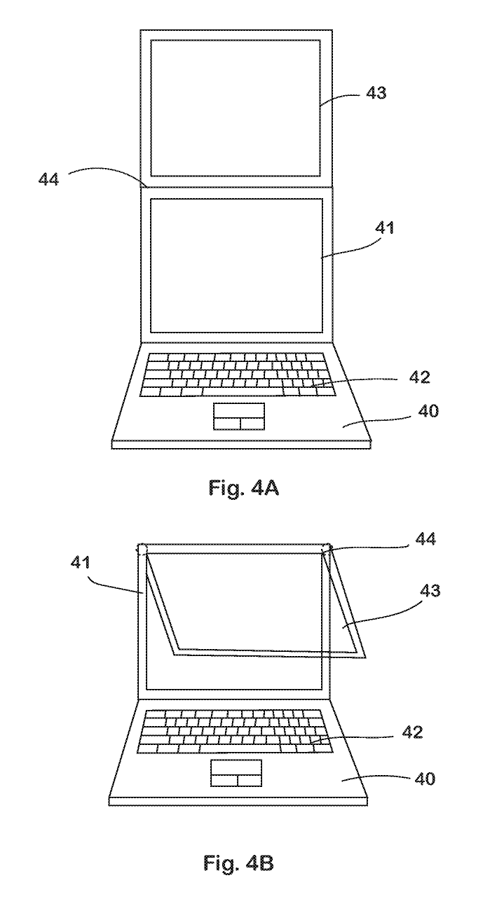

FIG. 4A is an illustration of the front view of the laptop device 40, and the inventive secondary screen 43 is hinged on to the top of the main screen 41 and shown in its upright position. In this embodiment, again the laptop device 40 is built with strong material and a heavier weight to withstand the top heavy aspect of the secondary screen 43. Although the extra weight added is used to balance the two screens and keyboard layer 42, and computer components below the keyboard layer, the weight is still sustainable for a user to manage. A rotatably hinged shaft 44 couples the main screen 41 to the to the secondary screen 43. It is an object of this embodiment to illustrate that the secondary screen 43 can be rotated at various angles to accommodate a user's preference. The hinged shaft 44 is similar to a door hinge wherein the secondary screen 43 can be adjusted to different angles. This embodiment is particularly useful for software programmers. Often times, programmers need to pull an existing code in one screen and then pull up an identical code and perform a debug process. The debugging often requires the need to view the previous code at the same time as performing the debug operation. In this instance having the secondary screen 43 directly above the main screen 41 allows the user the benefit of viewing both codes. As mentioned above, in today's fast moving technology market, many software programmers are performing tasks on laptops and notebooks while being away from the main office. Engineers, computer scientists, and other industries disciplines require employees to work on the go and laptops are the essential tool for performing tasks outside the office. With the secondary screen 43 positioned directly above the main screen 41, space, in particular can be saved for users who are traveling and are required to work on the airplane as one example. Space on the airplane is limited and having the secondary screen on the side of the laptop may interfere with a passenger's space. However, since space is available vertically, the secondary screen being positioned directly above the main screen allows the user to perform the tasks while restricted to the space of a passenger on a plane.

FIG. 4B is an illustration of an isometric view of FIG. 4A and of the present invention. In this view, the laptop device 40, and the inventive secondary screen 43 is hinged on to the top of the main screen 41. The secondary screen 43 is flipped backwards and used as a stand for stability purposes for the main screen 41. In this embodiment, again the laptop device 40 is built with strong material and a heavier weight to withstand the top heavy aspect of the secondary screen 43. Although the extra weight added is used to balance the two screens and keyboard layer 42, and computer components below the keyboard layer, the weight is still sustainable for a user to manage. A rotatably hinged shaft 44 couples the main screen 41 to the secondary screen 43. It is an object of this embodiment to illustrate that the secondary screen 43 can be rotated at various angles to accommodate a user's preference. The hinged shaft 44 is similar to a door hinge wherein the secondary screen 43 can be adjusted to different angles. This embodiment is particularly useful for software programmers as mentioned in FIG. 4A. Often times, programmers need to pull an existing code in one screen and then pull up an identical code and perform a debug process. The debugging often requires the need to view the previous code at the same time as performing the debug operation. In this instance having the secondary screen 43 directly above the main screen 41 allows the user the benefit of viewing both codes. With this embodiment, when the secondary screen 43 is not in use, the secondary screen can be folded down to rest up against the keyboard layer 42, and then the main screen 41 can be folded down similar to standard laptops and notebooks to rest in a closed position over the secondary screen 43.

As mentioned above, in today's fast moving technology market, many software programmers are performing tasks on laptops and notebooks while being away from the main office. Engineers, computer scientists, and other industries disciplines require employees to work on the go and laptops are the essential tool for performing tasks outside the office. With the secondary screen 43 positioned directly above the main screen 41, space, in particular can be saved for users who are traveling and are required to work on the airplane as one example. Space and stability on the airplane is limited since shaking and turbulence can affect the user's ability to work on the laptop. By having the ability to rotate the secondary screen 43 at various angles and all the way back for stability as shown in FIG. 4B, the user is able to have a stable laptop device for work and entertainment purposes as another example. Another advantage of being able to rotate the secondary screen 43 is to allow a second user , such a colleague or friend for example, who is sitting directly across from the first user to view the work that the first user is performing. The secondary screen 43 has the ability to flip the content shown on its screen to show it upright to the second user. This way both the first and second user can view the information or content on the screen simultaneously. This can be advantageous for many reasons and the added benefit of having the secondary screen is not just for the first user but can also be used to share information to a second user. Since the secondary screen 43 is communicatively coupled to the processor of the laptop device 40 so that both screens can display information from one processor.

Although one or more embodiments of the newly improved invention have been described in detail, one of ordinary skill in the art will appreciate the modifications to the material selection and the addition of a secondary dual screen option along with the new footprint layout of the laptop device. In particular, by adding the secondary dual screen option to laptop technology, users can perform tasks that are currently tedious to accomplish with only one main screen. It is acknowledged that obvious modifications will ensue to a person skilled in the art. The claims which follow will set out the full scope of the claims.

1. A laptop comprising an adjustable primary display screen that is mechanically and electronically coupled to a flat body that integrates a keyboard, at least one processor, at least one memory, at least one pointing device and at least one internal battery, said laptop further comprising a secondary display screen communicatively coupled to said at least one processor, wherein said secondary display screen is a standalone layer residing in a hollow space underneath said keyboard, said secondary display screen being coupled to an extending shaft member, said extending shaft member being coupled to a release and lock button on said flat body's side, wherein when said button is pushed to release, said standalone layer with said secondary display screen springs out enough such that a user can grab and pull said secondary display screen and said shaft member out together, and wherein said secondary screen can be rotated up and aligned to said primary screen.

2. A laptop comprising an adjustable primary display screen that is mechanically and electronically coupled to a flat body that integrates a keyboard, at least one processor, at least one memory, at least one pointing device and at least one internal battery, said laptop further comprising a secondary display screen communicatively coupled to said at least one processor, wherein said secondary display screen is a standalone layer coupled to said primary display screen's backside via a hinge and lock device, wherein when said standalone layer with said secondary display screen can be unfolded and aligned to said primary screen.

3. A laptop comprising an adjustable primary display screen that is mechanically and electronically coupled to a flat body that integrates a keyboard, at least one processor, at least one memory, at least one pointing device and at least one internal battery, said laptop further comprising a secondary display screen communicatively coupled to said at least one processor, wherein said secondary display screen is a standalone layer residing in a hollow space behind said primary display screen, said secondary display screen being coupled to an extending shaft member, said extending shaft member being coupled to a release and lock button on said primary screen's side, wherein when said button is pushed to release, said standalone layer with said secondary display screen springs out enough such that a user can grab and pull said secondary display screen with said shaft member out together, and wherein said secondary screen can be aligned to said primary screen.
